(19) United States
(12) Patent Application Publication
(10) Pub. No.: US 2009/0134048 A1
(43) Pub. Date: May 28, 2009

(54) MERCHANDISE AND ASSOCIATED MANUFACTURING METHOD

(75) Inventors: Noel Zeh, Launsbach (DE); Max Berger, Giessen (DE)

Correspondence Address: SALTER & MICHAELSON;THE HERITAGE BUILDING, 321 SOUTH MAIN STREET, PROVIDENCE, RI, 029037128, US

(73) Assignee: NOAX GMBH, Giessen (DE)

(21) Appl. No.: 12/038,166

(22) Filed: Feb. 27, 2008

(30) Foreign Application Priority Data
Nov. 22, 2007 (DE) 10 2007 056 485.8

(51) Int. Cl. B65D 85/18; B65D 85/57; G06Q 30/00; G06Q 90/00

(52) U.S. Cl. 206/278; 206/308.1; 705/1

(57) ABSTRACT

Merchandise that is of a textile product such as a T-shirt, in combination with a packaging container for holding the textile product. The packaging container has substantially the same dimensions of the packaging container for an audio or video carrier. The packaging container is provided with a visual theme associated with the main product.

### TECHNICAL FIELD

The present invention relates to the field of merchandising, in particular as it relates to textiles, and an improved method for the distribution of those textiles. The present invention further pertains to textiles (e.g. merchandise), which are packed in outer packages that are equal in size to the outer packages of Videos, DVDs, CDs and Cassettes. The present invention also relates to the inter-association of the textile with a performer (entertainment or sports) and the performers Videos, DVDs, CDs and Cassettes.

### BACKGROUND OF THE INVENTION

At the present time items such as DVDs and CDs are displayed on racks that are specifically constructed to receive and support the DVDs and/or CDs. If there is any merchandise, such as T-shirts, that relates to the DVDs or CDs or the related performers, that is typically displayed with a totally different support structure and at a different location in comparison to where the DVDs or CDs are displayed.

A search of the prior art has uncovered a German website identified as www.vs-service.de/werbeartikel/textilien.htm. This website simply describes a packaging scheme for T-shirts or towels in which the item is pressed into shape and held in shape by two cardboard pieces. In this description there is no disclosure to package the pressed textile into a packaging equal in size to the packaging for video or audio carriers. Furthermore, there is no inter-relationship between the indicia or design that is printed onto the textile and the main product such as a popular DVD, CD, etc. Also, in the website product, in order to be ready to be used (and unfolded) the pressed article has to be put into warm water. Such a treatment is not necessary for the pressed articles of the present invention.

Another prior art reference is the Korean Patent KR20030013726 “Method for vacuum compression packaging textile goods and pressed material”. This reference describes a packaging scheme similar to that shown in the above website using vacuum compression to package a T-shirt in a hardboard box. As with the other reference, there is no disclosure to package the pressed textile into a packaging equal in size to the packaging for video or audio carriers. Furthermore, there is no inter-relationship between the indicia or design that is printed onto the textile and the main product such as a popular DVD, CD, etc.

### SUMMARY OF THE INVENTION

According to the present invention, merchandise is offered (textiles, like clothes, such as T-shirts), whose outer package presents the same, or essentially the same dimension, as the relevant CD or DVD.

According to the present invention, merchandise presents the same, or essentially the same format as the relevant CD or DVD. In this way it is possible to place the packaged merchandise in the same rack, directly next to the corresponding main product. The main product in accordance with the present invention may be a video or audio carrier such as the well-known DVD or CD. One advantage of the concept of the present invention is that no separate racks are needed for the display of the textile product, since the outer package or container presents essentially the same dimension as that of a standard DVD or CD.

Now, in accordance with one embodiment of the present invention there is provided merchandise that is comprised of a textile product, in combination with a packaging container for holding the textile product. The packaging container has substantially the same dimensions of the packaging container for an audio or video carrier and the packaging container is provided with a visual theme.

In accordance with other aspects of the present invention the textile product may be a piece of clothing, such as a t-shirt; the audio or video carrier is selected from the group of a video tape, a DVD, a CD and a music cassette; the visual theme may characterize a band, musical group, entertainer, musician, sports team or sports figure; the textile product if a t-shirt, the packaging container has the dimensions of a DVD packaging container; the packaging container preferably has a width on the order of 14.5 centimeters, comparable to the width of a container for a DVD; more specifically the packaging container may have a width on the order of 14.5 centimeters, a height in a range of 12.5 to 19 centimeters, and a depth on the order of 1.9 centimeters; the packaging container can be constructed of paperboard, plastic or metal; and the textile product may also be provided with a visual theme that substantially matches that on the packaging container.

In accordance with still another aspect of the present invention the merchandise is considered as in combination with a rack for holding the packaging container, and in which the packaging container for the video or audio carrier is displayed on the rack in juxtaposition to the packaging container for the textile product. The packaging container for the video or audio carrier and the packaging container for the textile product may have like themes visible thereon.

In accordance with a further aspect of the present invention there is provided a use of the merchandise as defined above in the music industry, film industry, book industry or for video games.

In accordance with still a further aspect of the present invention there is provided a process for the production of merchandise as defined above and further comprising the following steps: (1) folding the textile product into a predetermined format, (2) pressing the folded textile product with substantial removal of air therefrom, and (3) inserting the folded and pressed textile product into the packaging container having the dimensions of the packaging container for a video or audio carrier. The process may further include, after the pressing step, the step of shrink-wrapping the pressed textile product so as to maintain the pressed format. The process may also include, not only pressing to remove air, but also pressing to remove any moisture.

Now, in accordance with a second embodiment of the present invention there is provided a packaging container for holding both a piece of merchandise and a video or audio carrier, and in which the packaging container comprises multiple sections including at least a first section that releasably supports the video or audio carrier and at least a second section that removably supports the piece of merchandise.

In accordance with other aspects of this second embodiment the first section has a pair of outer holders that each supports a respective video or audio carrier and that each are hingedly mounted from the second section; the piece of merchandise comprises a textile product and the second section of the packaging container includes a peripheral frame having a width that is sufficient to hold a folded textile product; and the peripheral frame is disposed between the pair of outer holders when the packaging container is closed.

### DESCRIPTION OF THE DRAWINGS

It should be understood that the drawings are provided only for the purpose of illustration and are not intended to define the limits of the disclosure. The foregoing and other features and advantages of the embodiments that are described herein will now become apparent with reference to the following detailed description when taken in conjunction with the accompanying drawings, in which:

FIG. 1 is a front view of a first embodiment of the packaging container of the present invention;

FIG. 2 is a rear view of the packaging container of FIG. 1;

FIG. 3 is a perspective view of the container of FIG. 1 in its closed position;

FIG. 4 is a perspective view of the container of FIG. 1 showing the t-shirt;

FIG. 5 illustrates the t-shirt alone;

FIG. 6 illustrates a typical rack that can be used in supporting the packaging container for the textile product and the main product;

FIG. 7 is a perspective view of a second embodiment of the present invention in a closed position and in which the textile product and video or audio carrier are commonly supported;

FIG. 8 is a perspective view of the second embodiment of FIG. 7 in an open position and without the t-shirt in place;

FIG. 9 is a perspective view of the second embodiment of FIG. 7 in an open position and with the t-shirt in place;

FIG. 10 is a cross-sectional view of the second embodiment and helpful in illustrating the manner in which the textile product is supported; and

FIG. 11 is a perspective view of a third embodiment of the present invention and in an open position;

FIG. 12 is a perspective view of the embodiment of FIG. 11 with components partially exploded away to show the various components that comprise the packaging;

FIG. 13 is a perspective view of one of the removable sections of the packaging;

FIG. 14 is a cross-sectional view taken along line 14-14 of FIG. 13;

FIG. 15 is an enlarged cross-sectional view showing further details of the panel member; and

FIG. 16 is a further perspective view illustrating a slight variation to the embodiment described in FIGS. 11-15.

### DETAILED DESCRIPTION

The merchandise and associated method of the present invention enables the support and display of a textile product as though it were in a container as for a main product. The main product can be an article of the music, video, sports or other industries. The merchandise preferably has the same logo or transports the same message as the related main product. For example, a huge offer of merchandise exists for known artists and bands and their individual CDs and DVDs. As indicted previously, in the past this merchandise has not be directly associated with the main product itself, but has instead been displayed separately and in a totally different manner. In accordance with the present invention, however, for the distribution and marketing of merchandise, the packaging container for a textile product is preferable placed in trade directly next to the main product. For example, if the main product is a DVD of a popular band, then the associated packaging container for the textile product is displayed in juxtaposition. The packaging container for the textile product carries a theme like that of the DVD. In a second embodiment that is described in more detail hereinafter both the textile product and the DVD are supported in a common packaging container.

In a preferred embodiment of the present invention, the merchandise is textiles such as clothing, particularly t-shirts that are popular with those that follow a particular band or group. The merchandise may also include such other items as lanyards, buttons or tickets. The merchandise can correspond to musicians, bands, single CDs of musicians and bands, films, videogames and athletes or sport teams etc.

According to the present invention the merchandise features basically the same dimension of the sound and/or picture carrier, like CDs, DVDs, video tapes, music tapes, etc. In order to be suitable for the same racks, the packaging container of the present invention preferably is of the same width of the corresponding main product; in other words of the DVD or CD package itself. The width of the textile product container is preferably on the order of 14.5 centimeters so as to be readily accommodated in existing support racks. The textile container can be made of any one of a number of different types of material. Examples are paperboard, plastic or metal. The outer surface area of the textile packaging container carries a theme similar to that on the main product (DVD or CD).

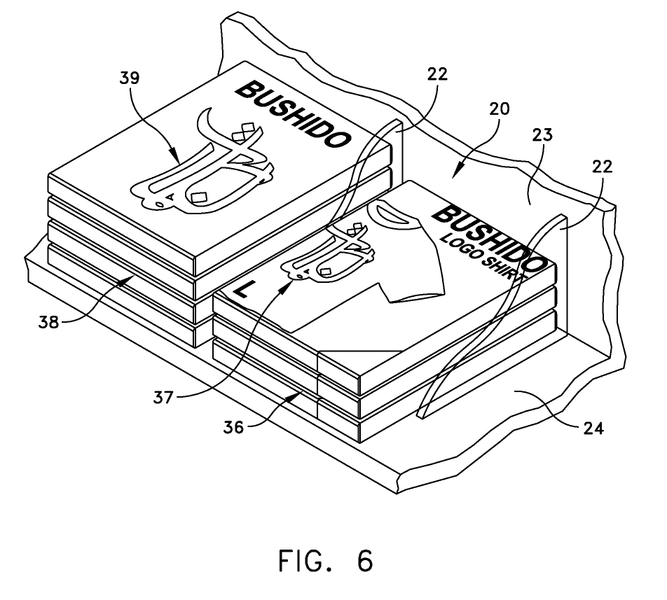

The present invention therefore offers a valuable merchandising technique, which can be presented in many ways. According to the invention, the merchandise products can be placed in the trade and be distributed like corresponding audio and picture carriers (CDs, DVDs) without any additional work. The same racks can be used for the display of either or both (see for example FIG. 6), and the method provides an automatic association between the textile product and the main product due to common themes on them. The common themes may, for example, be the name of a musical group, an associated logo, a musical or video song title, or a number of other associating themes.

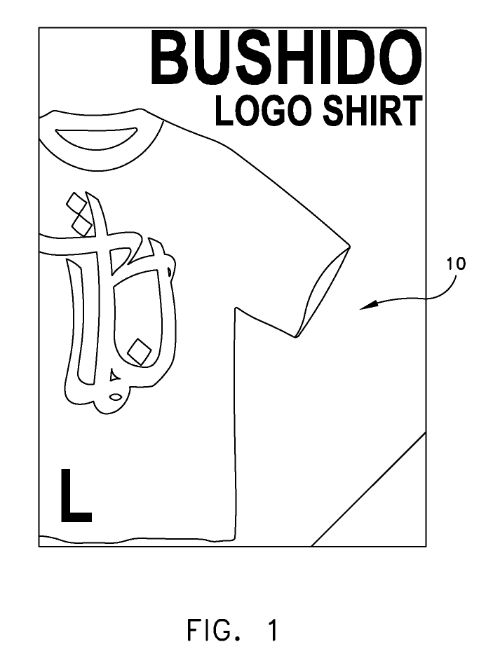

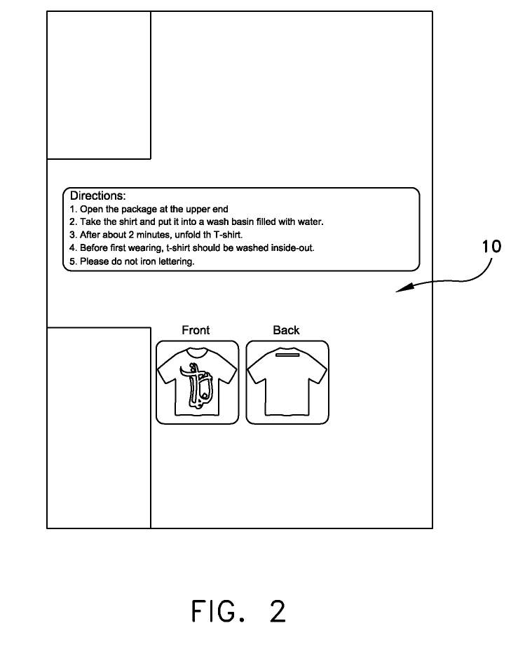

According to a preferred embodiment as shown by way of example in FIGS. 1 and 2, the invention relates to a T-Shirt packaged in an outer package, which has the dimension of a DVD. The T-Shirt, the packaging or both show a user-defined image or writing, characteristically for a music DVD. For example, the theme may be the name and/or logo of a certain DVD of a musician or band. The so-called DVD-Shirt can be sold as merchandise via the audio media business, book trade or non-music trade. A distinct advantage of the DVD-Shirt is that merchandise can be distributed like CDs and DVDs. Distributors can ship this product like they ship DVDs and the trade does not need additional shelves/racks, since the DVD-Shirt can be placed in already existing racks, as illustrated in the fragmentary view of FIG. 6.

The main product (e.g. the artist, a song, a film, a tour, a premiere etc.) can be marketed additionally by inlays, which can be placed into the DVD-Shirt. Also, a concert ticket could be packed e.g. shrink wrapped, with the DVD-Shirt. Consequently, the tour-shirt is sold in combination with the matching ticket. The same can be considered for vouchers used for ring tones etc. The DVD-Shirt is suitable for the book and audio book sector, as well. The DVD shirt could also be sold out of vending machines at concerts and in video stores.

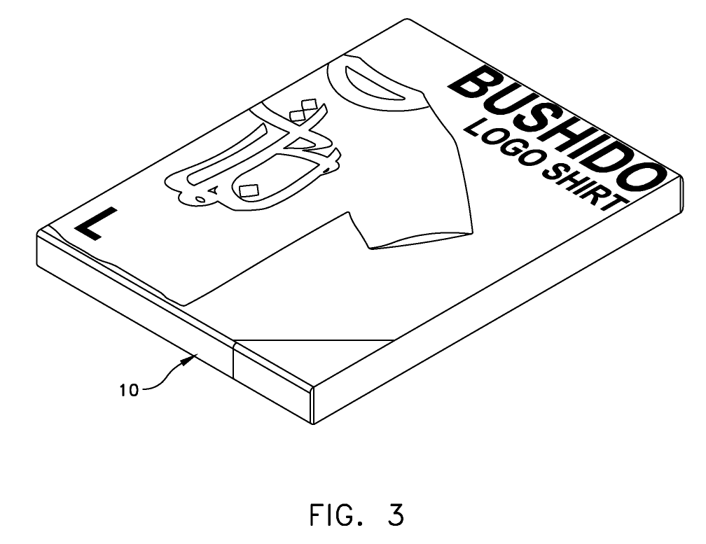

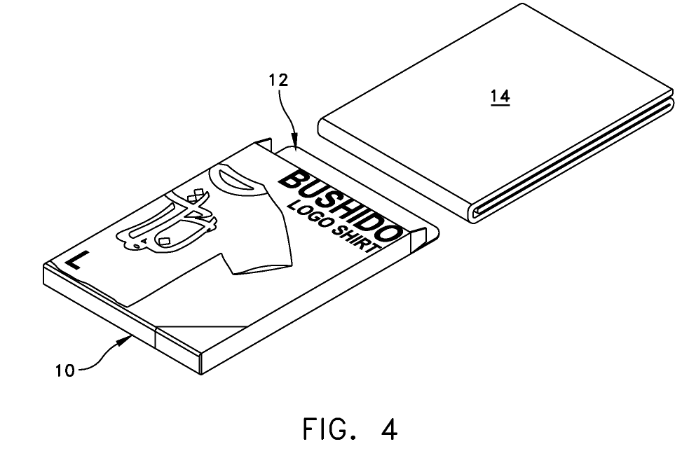

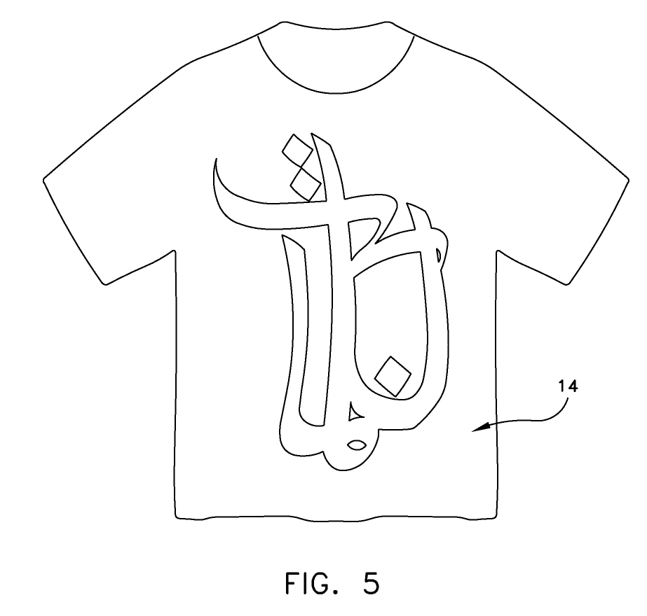

FIG. 1 is a front view of a first embodiment of the packaging container 10 of the present invention, while FIG. 2 is a rear view of the packaging container 10 of FIG. 1. The container may be provided with a thin clear plastic wrap for display purposes. One example of a container for packaging purposes has approximate measurements of 12.5 cm to 19 cm in height, about 14.5 cm in width and about 1.9 cm in depth. Refer also to FIGS. 3 and 4 for perspective views of the container 10. FIG. 3 shows the depth dimension. The container may be provided with at least one end that has a flap that enables the T-shirt to be inserted into the container. This flap is shown at 12 in FIG. 4. FIGS. 4 and 5 also depict the T-shirt 14. In FIG. 4 the T-shirt is shown folded while in FIG. 5 it is shown opened for use.

Any operation to manufacture the merchandise, like the DVD-Shirt, can be used. For example clothes, like a T-Shirt can be folded into the required format (e.g. size, shape). Afterwards the folded piece of clothing is going to be pressed along with removal of wetness and air and can then later be shrink-wrapped, such as by using a plastic foil or layer. This enables the textile product to keep its format (shape). Later the textile product 14 is to be packed into the desired packaging, as illustrated in FIG. 4 where the T-shirt 14, in its folded condition, is about to be inserted into the container or packaging 10. These single steps can be carried out automatically or manually. The shrink-wrapping is optional.

FIG. 6 illustrates a typical rack 20 that can be used in supporting the packaging container for the textile product and the main product. This illustrates the manner in which the textile product, shown at 36 in FIG. 6 can be displayed in juxtaposition to the main product, shown at 38 in FIG. 6. Only a portion of the rack 20 is illustrated in FIG. 6 including transparent divider walls 22 a back wall 23 and a base 24. Various other forms of racks, supports or holders may be considered for the associated display of the main product and textile product. As indicated before the same basic rack structure can be used for the display of both the textile product and the main product (DVD or CD). In FIG. 6 note the common themes indicated at 37 and 39 associated respectively with the products 36 and 38. In FIG. 5 this particular theme is a “logo”, but could be any other of many different themes such as a song title of performers or groups name.

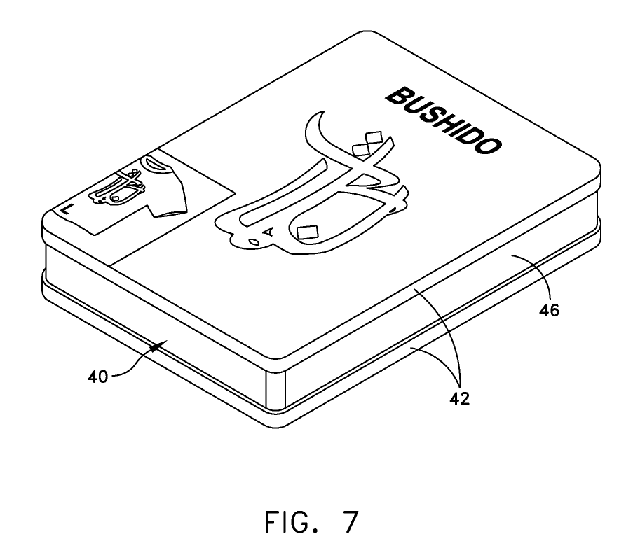

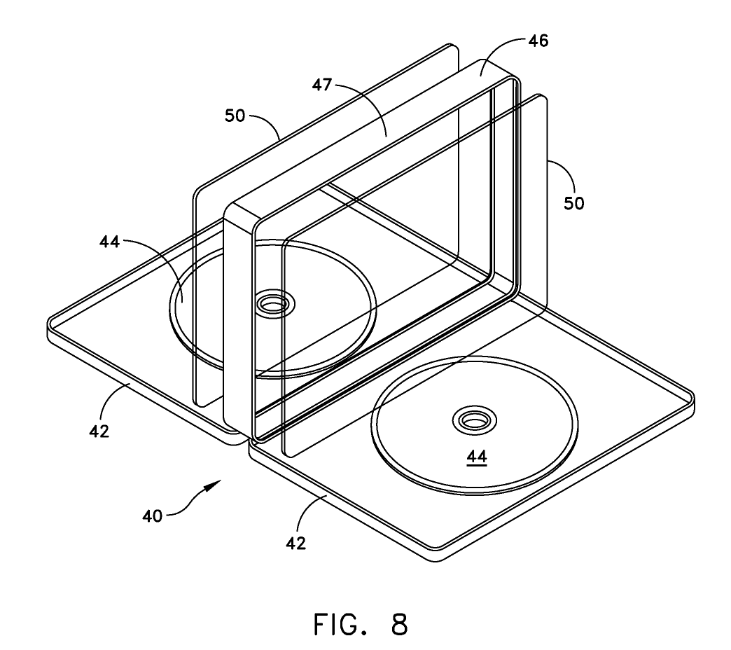

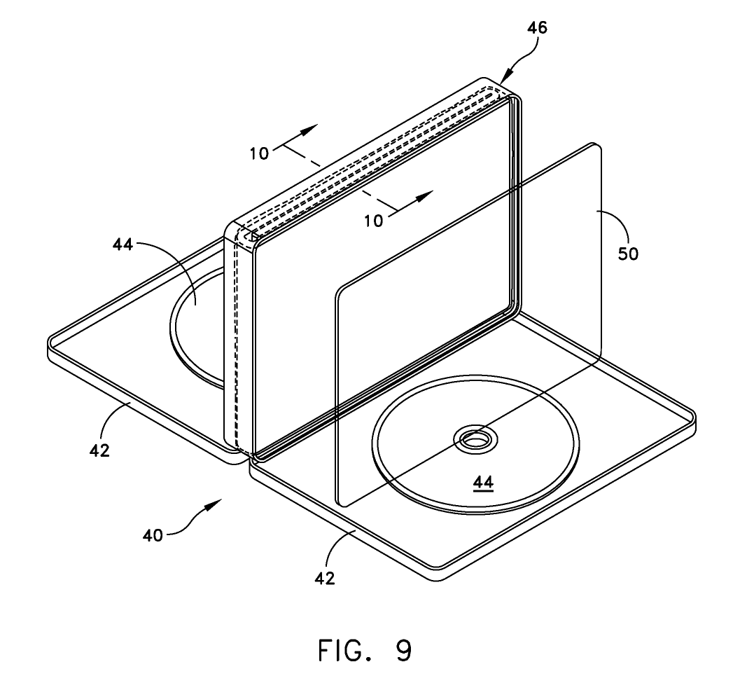

Reference is now made to FIG. 7 which is a perspective view of a second embodiment of the present invention in a closed position and in which the textile product and video or audio carrier are commonly supported. FIG. 7 shows the common container 40. FIG. 8 is a perspective view of the second embodiment of FIG. 7 in an open position and without the T-shirt in place. FIG. 9 is a perspective view of the second embodiment of FIG. 7 in an open position and with the T-shirt in place. FIG. 10 is a cross-sectional view of the second embodiment taken along line 10-10 of FIG. 9 and helpful in illustrating the manner in which the textile product is supported.

The packaging container 40 is for holding both a piece of merchandise and a video or audio carrier. The packaging container comprises multiple sections including at least a first section that releasably supports the video or audio carrier and at least a second section that removably supports the piece of merchandise, or in the case illustrated a T-shirt. In FIGS. 7-10 the packaging container 40 includes a pair of outer holders or leafs 42 that each supports a respective video or audio carrier 44. Each of the holders 42 are hingedly mounted from the second section, which is shown in the drawings as section 46. The second section of the packaging container is illustrated as including a peripheral frame 47 having a width that is sufficient to accommodate a folded textile product.

The frame 47 is preferably rectangular and is provided with grooves or notches 48 that are spaced apart and that each receive a panel 50 which may be transparent. The notches can be provided on the inner surface of the frame of the center section at least partially along the inner circumference of the frame, and can be provided on multiple sides of the frame. As can be seen in the drawings, the center section 46 is provided for storing the T-shirt 60. The center section is provided on both sides with layers or panels 50 which may be of cardboard, plastic etc. These panels 50 are for supporting the T-shirt, that is, the T-shirt is sandwiched between the two panels. FIG. 10 also illustrates a shrink-wrapping about the folded T-shirt at 65. The panels maintain the T-shirt in place. FIG. 7 shows the folded container 40.

In FIG. 8 the hinges would be at the bottom of the section 46 allowing both of the holders 42 to hinge relative to the center section in opening and closing the container. Once the product has been purchased the owner can easily open the container to provide access to the audio or video carriers. At the same time access is readily had to the center section 46 whereat the T-shirt is supported. The T-shirt can be easily removed by bending and deforming the panels 50 to allow the T-shirt to be removed. The second embodiment represents certain advantages. For example, both the textile and main products are then in a single container. A special fan package is thus produced and sold which offers value to the customer. This product is also readily adapted to existing racks as it has a similar width to existing DVDs or CDs.

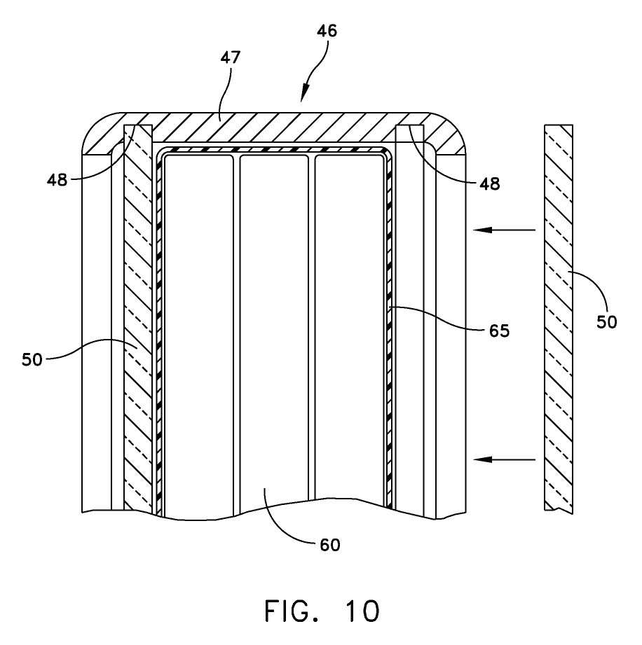

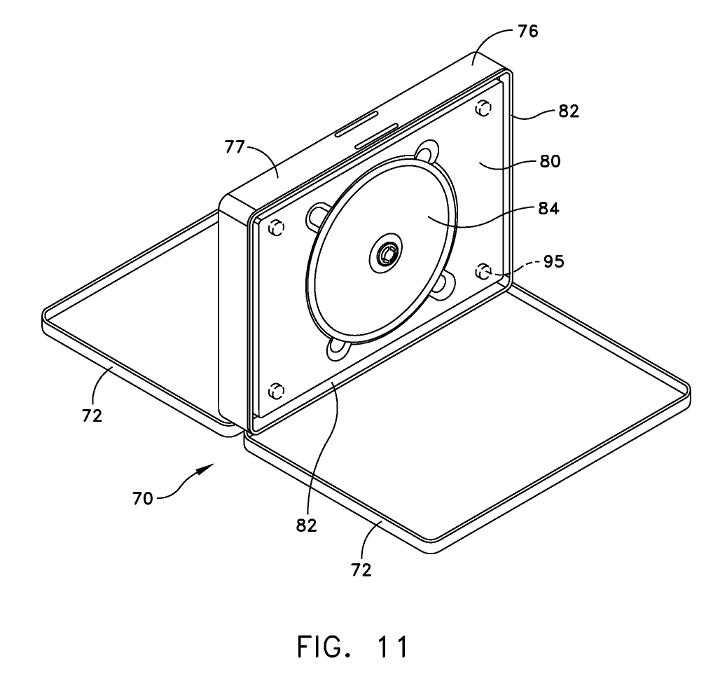

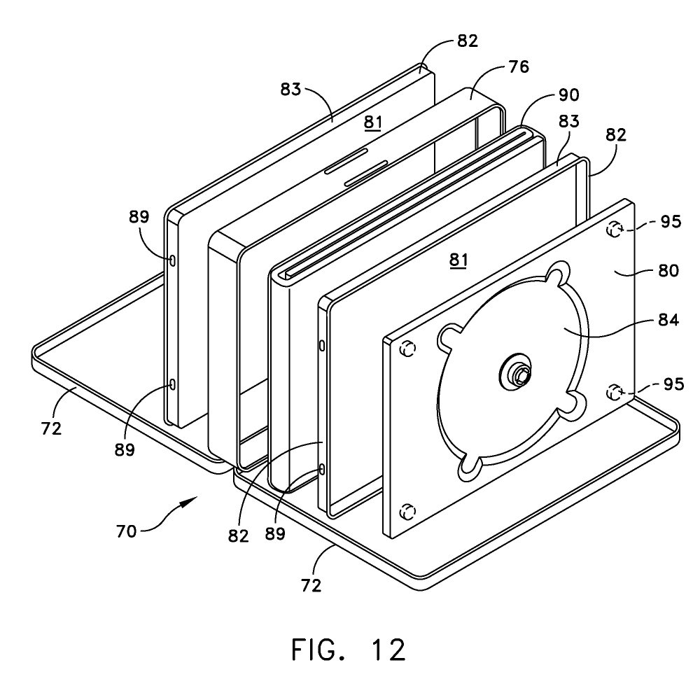

Reference is now also made to FIGS. 11-16 for still another embodiment of the present invention. This embodiment is similar to that shown in FIGS. 7-10. However, in place of the flat panel 50 shown in the embodiment of FIG. 8, there is illustrated a different panel that is in the form of a tray 82. Actually, there are opposite trays 82 that are adapted to fit within the center section 76. FIG. 12, for example, also shows between the trays 82 the packaged t-shirt at 90. This may be packaged in a thin plastic or cellophane wrapping and is held in place by simply engaging each of the trays 82 with the center section 76. To assist in holding the trays 82 in place, there are preferably provided pairs of dimples 89 at either side of the tray. The tray is defined by a bottom panel 81 and a peripheral edge 82 that forms a dished-out tray. The dimples 89 will engage the inner walls defining the center section 76. The center section 76 may be provided with slight depressions so that the dimples 89 will engage and be held in place relative to the center section 76.

In the embodiment of FIGS. 11-16 the packaging container comprises multiple sections including a pair of outer holders or leafs 72 that, in this particular embodiment, are not shown as supporting respective video or audio carriers. In an alternate embodiment, these holder or leafs 72 may also support a means for holding respective video or audio carriers. Each of the holders 72 are hingedly mounted together so that they can pivot between open and closed positions. A closed position is illustrated, for example, in FIG. 7 and an open position is one as illustrated in FIGS. 8, 9, 11 or 12. The holders 72 are hingedly mounted from the center section 76. The center section 76 includes a peripheral frame 77 having a width that is sufficient to accommodate the folded textile product 90, as well as to receive the respective trays 82.

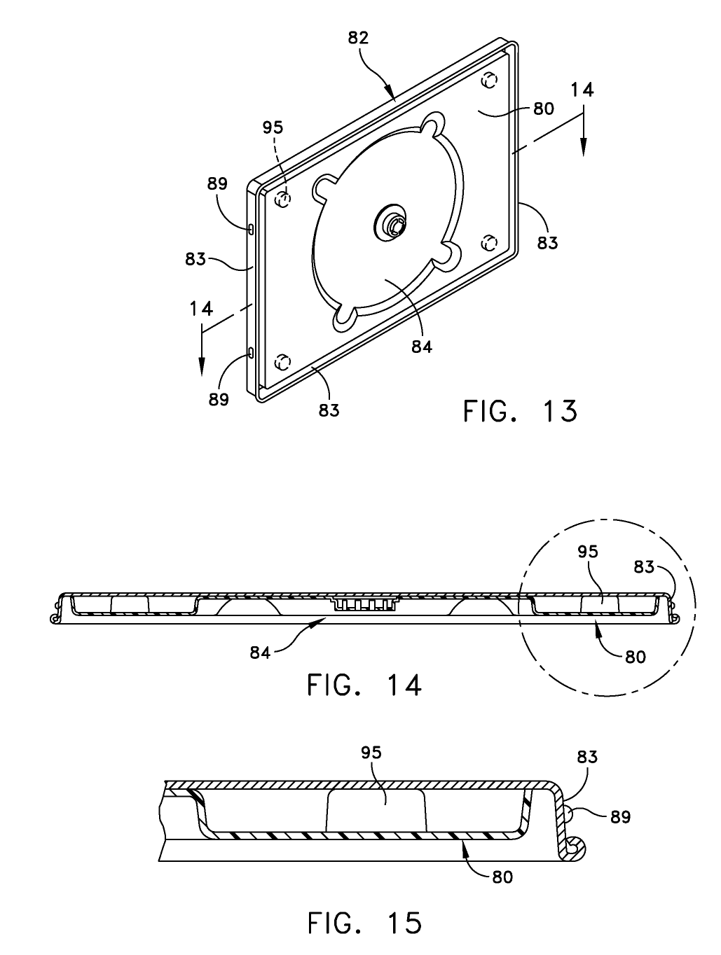

In order to support the video or audio carrier, there is shown in this particular embodiment a holder 80 that includes a center section 84 where the DVD or CD may be held. The construction of a center section 84 is conventional so as to properly receive the appropriate carrier. The holder 80 is provided with four oppositely disposed legs 95 that are adapted to be secured within each of the respective trays. Refer to FIG. 13 showing the holder 80 in place in one of the trays 82. Refer also to the cross-sectional views of FIGS. 14 and 15 for an illustration of the holder 80. These cross-sectional views also illustrate the edge ledge that extends around the entire periphery of the tray as well as the interlocking dimples 89.

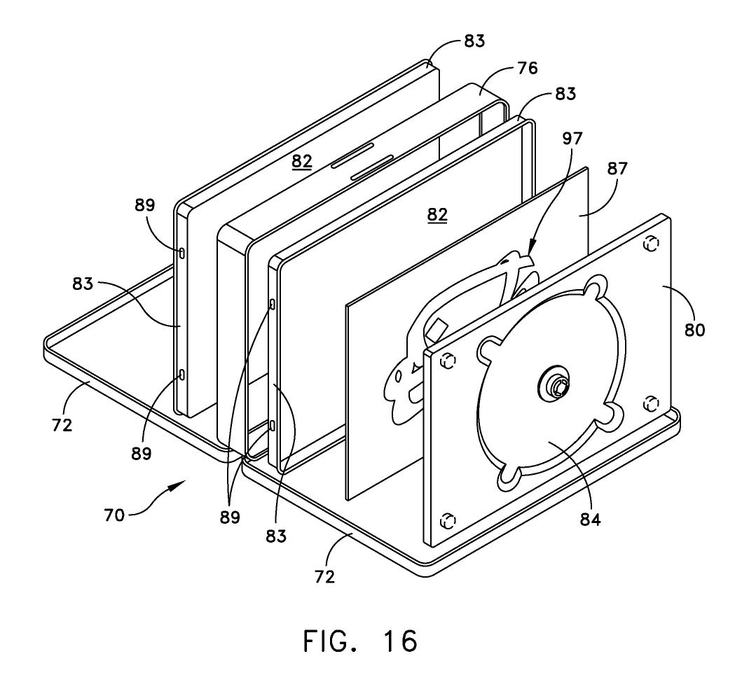

Reference is now made to FIG. 16. This embodiment is quite similar to the one illustrated in FIGS. 11-15 with the exception that there is an added panel 87 that may have indicia 97 disposed thereon. This indicia is usually associated with the particular carrier. When this extra panel 87 is used then the holder 80 is preferably transparent so that the indicia can be viewed therethrough.

In another embodiment of the present invention carrier holders may be provided both in the respective trays as well as in the holder sections 72.

Having now described a limited number of embodiments relating to the principles of the present invention, it should now be apparent to one skilled in the art that numerous other embodiments and modifications thereof are contemplated as falling within the scope of the present invention, as defined by the appended claims.

What is claimed is:

1. Merchandise that is comprised of a textile product, in combination with a packaging container for holding the textile product, said packaging container having substantially the same dimensions of the packaging container for an audio or video carrier, said packaging container provided with a visual theme.

2. Merchandise according to claim 1 wherein the textile product is a piece of clothing.

3. Merchandise according to claim 2 wherein the clothing is a t-shirt.

4. Merchandise according to claim 1 wherein the audio or video carrier is selected from the group of a video tape, a DVD, a CD and a music cassette.

5. Merchandise according to claim 1 wherein 1 wherein the visual theme characterizes a band, musical group, entertainer, musician, sports team or sports figure.

6. Merchandise according to claim 1 wherein the textile product is a t-shirt and the packaging container has the dimensions of a DVD packaging container.

7. Merchandise according to claim 1 wherein the packaging container has a width on the order of 14.5 centimeters, comparable to the width of a container for a DVD.

8. Merchandise according to claim 1 wherein the packaging container has a width on the order of 14.5 centimeters, a height in a range of 12.5 to 19 centimeters, and a depth on the order of 1.9 centimeters.

9. Merchandise according to claim 1 wherein the packaging container can be constructed of paperboard, plastic or metal.

10. Merchandise according to claim 1 wherein the textile product is also provided with a visual theme that substantially matches that on the packaging container.

11. Merchandise according to claim 1 in combination with a rack for holding packaging container, and in which the packaging container for the video or audio carrier is displayed on the rack in juxtaposition to the packaging container for the textile product.

12. Merchandise according to claim 11 wherein the packaging container for the video or audio carrier and the packaging container for the textile product have like themes visible thereon.

13. A use of the merchandise defined in claim 1 in the music industry, film industry, book industry or for video games.

14. A process for the production of merchandise according to claim 1 comprising the following steps: (1) folding the textile product into a predetermined format, (2) pressing the folded textile product with substantial removal of air therefrom, and (3) inserting the folded and pressed textile product into the packaging container having the dimensions of the packaging container for a video or audio carrier.

15. The process according to claim 14 including, after the pressing step, shrink-wrapping the pressed textile product so as to maintain the pressed format.

16. The process according to claim 15 including, not only pressing to remove air, but also pressing to remove any moisture.

17. A packaging container for holding both a piece of merchandise and a video or audio carrier, and in which the packaging container comprises multiple sections including at least a first section that releasably supports the video or audio carrier and at least a second section that removably supports the piece of merchandise.

18. A packaging container according to claim 17 wherein the first section has a pair of outer holders that each supports a respective video or audio carrier and that each are hingedly mounted from said second section.

19. A packaging container according to claim 18 wherein said piece of merchandise comprises a textile product and the second section of the packaging container includes a peripheral frame having a width that is sufficient to hold a folded textile product.

20. A packaging container according to claim 19 wherein the peripheral frame is disposed between the pair of outer holders when the packaging container is closed.

21. A business method comprising marketing merchandise in a container that corresponds in like to a container for a main recording product, and marketing the merchandise in juxtaposition with the main product.

22. The business method of claim 21 wherein the merchandise is textiles and the main product is selected from the group of audio and video carriers.

23. The business method of claim 22 wherein the main product is selected from the group of music, video, sports or related industries.

24. The business method of claim 21 wherein the merchandise container and main product container are displayed in juxtaposition in the same rack.

25. The business method of claim 21 wherein the merchandise container and main product container both carry like nomenclature.
